(19) United States
(12) Patent Application Publication
(10) Pub. No.: US 2009/0254484 A1
(43) Pub. Date: Oct. 8, 2009

(54) Anon virtual prepaid internet shopping card

(76) Inventors: Julio C. Forero, Port Saint Lucie, FL (US); Aracelly Forero, Port Saint Lucie, FL (US)

Correspondence Address: JULIO C. FORERO, 1249 Santiago Ave., Port Saint Lucie, FL, 34953, US

(21) Appl. No.: 12/380,076

(22) Filed: Feb. 24, 2009

Related U.S. Application Data
(60) Provisional application No. 61/072,865, filed on Apr. 3, 2008.

(51) Int. Cl. G06Q 20/00; G06Q 40/00

(52) U.S. Cl. 705/68

(57) ABSTRACT

The invention is a new generation of system of payments, designed for the millions of customers around the world who are victims of identity theft and fraud with credit card; because it is anonymous, prepaid, disposable, non-reloadable, non-refundable, and easy to doing any purchase online, telephone, mail or retailer. The invention has both features such as 1) is a prepaid debit card (expiration date & security code) and 2) is a prepaid phone card (PIN), with an amount assigned on every account/card, which is exhausted when the cash amount is expended and works with the same physical characteristics, electronic and financial mechanisms of a debit card as they do major credit cards, are an open loop. It is distributed by retailers (plastic card) or Internet (virtual account) and must be pre-activated for use after purchased.

### CROSS-REFERENCE TO RELATED APPLICATIONS

This application claims priority from Provisional Patent Application No. 61/072,865, filed on Apr. 3, 2008.

The present invention relates to a payment system to allow transmission of a purchase virtual or in person with an “anon prepaid shopping account or card”. The invention is designed for the millions of customers around the world who are victims of identity theft and fraud with credit cards, without revealing the identity of the holder and using an anonymous name, at the time to do the purchase, to prevent abuse and the fraudulent use of personal and financial information support over the Internet. The invention has both features such as: 1) is a prepaid debit card (expiration date & security code), and 2) is a prepaid phone card (personal identification number), with an amount assigned on every account or card. The invention works with the same physical characteristics, electronic and financial mechanisms of a debit card as they do major credit cards. Is distributed by retailers (plastic card) or by Internet (virtual account) and is anonymous, disposable, not-reloadable, and easy to use, not uses encryption, is an open loop network, is based on existing Internet protocols and must be pre-activated after purchase for use.

### CROSS-REFERENCE TO OTHER RELATED PATENT APPLICATIONS

U.S. Patent References:

| | | | |
|---|---|---|---|
| 4706275 | Telephone system | November 1987 | Kamil |
| 5577109 | Pre-paid card system and method | March, 1995 | Stimson |
| 5744787 | System and method for retail | September, 1995 | Skjerven, |
| 5721768 | Pre-paid card system and method | November, 1996 | Stimson |
| 5745555 | System and method using PIN | April, 1998 | Mark |
| 5852812 | Billing system for a network | December, 1998 | Reeder |
| 5909492 | Network sales system | June, 1999 | Payne |
| 5953710 | Children's credit or debit card system | September, 1999 | Fleming |
| 5956699 | System for secured C/card trans/internet | September, 1999 | Wong. |
| 5970472 | Performing electronic commerce internet | October, 1999 | Allsop |
| 5984180 | Method and system for gift credit card | November, 1999 | Albrecht |
| 5991413 | Process for the acceptance of a virtual P/C | November, 1999 | Arditti l. |
| 6014636 | Point of sale method and system | January, 2000 | Reeder |
| 6070150 | Electronic bill and payment system | May, 2000 | Remington |
| 6070154 | Internet credit card security | May, 2000 | Tavor |
| 6088683 | Secure purchase transaction | July, 2000 | Jalili |
| 6092198 | System and method for enabling controlling | July, 2000 | Lanzy |
| 6098053 | System and method for performing an elect | August, 2000 | Slater |
| 6115458 | Method and apparatus of prepaid Instru. | September, 2000 | Taskett |
| 6125352 | System/method for conducting commerce | September, 2000 | Franklin |
| 20020046341 | System, method for prepaid anonymous | January, 2001 | G. Cary |
| 7082416 | Method of using prepaid cash card | December, 2001 | R Schaap |
| 20010037209 | Prepaid payment system/anonymous Purchases | November, 2001 | Tarbutton |
| 7441697 | Limited use pin system and method | June, 2001 | S & Wt |
| 6467684 | Pre-paid card system for purchasing P of S | October 2002 | Fite |
| 20020077973 | Method/apparatus issuing prepaid e-cash | June, 2002 | Ronchi l. |
| 20020174016 | Multiple accounts and purposes card | November, 2002 | Cuervo |
| 20020184143 | Khater plus system | December, 2002 | Khater |
| 6556674 | Platform for prepaid calling card calls | December, 2002 | AT&T |
| 6405182 | System for dispensing prepaid debit cards | June, 2002 | Cuervo |
| 6473500 | System/Method for using a prepaid Cards | October, 2002 | Risafi |
| 20020065727 | POS System | May, 2002 | Fujitsu |
| 20050021412 | Prepaid Internet Card | December, 2002 | J, Wilson |
| 6526130 | System/method distributing PIN over PC | February, 2003 | Paschini |
| 6542601 | Method/system automated customer supp. | April, 2003 | Hernandez |
| 6581827 | Universal prepaid telecom services card | June, 2003 | Welton |
| 20030225630 | Electronic shopping mall | June, 2003 | Kakuta, |
| 20030001005 | System/method for using a prepaid card | January, 2003 | Risafi. |
| 20030028481 | Credit card system and method | February, 2003 | Flitcroft |
| 20030069846 | Multi-function electronic transaction card | April, 2003 | Marcon |
| 20030078896 | Systems facilitating automated confirmation | April, 2003 | Fox |
| 20030095646 | System and method for PIN numbers/PC | May, 2003 | Paschini |
| 20030200179 | Method/Program to make Payment | October, 2003 | Kwan |
| 5760381 | Prepaid card | May, 2003 | N & V |
| 20040083184 | Anonymous card transactions | April, 2004 | Tsuei |
| 20050144093 | E-commerce shopping | May, 2004 | F. Gerb |
| 20040006539 | System and method a dispute | January, 2004 | Royer |
| 20040026518 | Plastic card | February, 2204 | B & R |
| 20050203843 | Internet debit system | March, 2004 | Gleen |
| 20050010483 | Methods/apparatus transacting commerce | January, 2005 | Ling |
| 20050182720 | Online Payment System & Method | January, 2205 | H & P |
| 20060076400 | Limited Use PIN System Method | April, 2006 | Fletcher |
| 7418398 | Stored Value Cards | May, 2006 | T & T |
| 7246752 | Magnetic Stripe Card | April, 2006 | M Rich |
| 20070175984 | Open-Loop Gift Card System & Method | January, 2007 | Axios Law |
| 20070228161 | Limited Use PIN System Method | October, 2007 | Fletcher |

Foreign References:

| | |
|---|---|
| JP11203560 | July, 1999 |
| WO-0067214 | November, 2000 |
| EP1115095 | July, 2001 |
| GB2361790 | October, 2001 |
| WO/1997/009688 | March, 1997 |
| WO/1999/049424 | September, 1999 |
| WO/2000/049586 | August, 2000 |

Other References:

“Internet's First Pre-Paid Shopping Card Launched,” PR Newswire, Sep. 21, 1999.

“InternetCash Micro E-Cash Service Being Developed,” Newsbytes News Network, Sep. 29, 1999.

Wilder, C., “E-commerce Goes Plastic,” InformationWeek, Nov. 29, 1999, p. 11.

Young, J., “Cybermoola,” Youth Markets Alert, vol. XI, No. 11, p. 5, November 1999.

Nelson, K., et al., “Buying Power for the Internet,” Bank Systems+Technology, vol. 37, No. 1, p. 20, January 2000.

“Credit Cards no Longer Necessary for E-Commerce,” Direct Marketing, vol. 62, No. 12, p. 15, April 2000.

“InternetCash Gains Ground on Credit Cards,” Business Wire, May 17, 2000.

Tillett, L. S., “Merchants Grapple with Payment Options-Integration Still a Hurdle as Credit-Card Alternatives Emerge,” InternetWeek, p. 14, May 22, 2000.

“RealStores.com Now Accepting InternetCash for E-Commerce Transactions,” Business Wire, p. 2235, Jun. 13, 2000.

Bielski, L., “New Wave of E-Money Options Hits the Web,” American Bankers Association, ABA Banking Journal, vol. 92, No. 8 p. 39, August 2000.

“Ante up Your ‘Cybermoola,’” DSN Supercenter and Club Business, vol. 7, No. 19, p. 6, Oct. 9, 2000.

Martin, Z., “A Dearth of Marketing Power,” Credit Card Management, vol. 13, No. 8, pp. 47-52, November 2000.

Breitkopf, D., “Prepaid Cards Try to Build a Mass Market,” American Banker, vol. 166, No. 36, p. 1, Feb. 22, 2001.

“Debit Cards Hold Advantages for Supermarkets,” PR Newswire, Nov. 21, 1988.

“Credit Cards Can Buy Groceries,” Leader Herald, Apr. 5, 1992.

Gage, T. J., “Retail POS Debits Finally Take off,” Corporate Cashflow, vol. 14, No. 10, pp. 19-20, September 1993.

“Three for All,” Card Fax, vol. 96, No. 108, p. 2, Jun. 24, 1996.

Redman, R., “Interface Enables Phone Downloads,” Bank Systems & Technology, vol. 34, No. 12, p. 17, December 1997.

“Quick Hits,” Debit Card News, Mar. 31, 1999.

“Solutran Offers E-Commerce Pay Alternative,” Card News, vol. 15, No. 14, Jul. 12, 2000.

“DataWave TeleCard Machines Provide New Business Venue” (Abstract), Vending Times, p. 49, Apr. 14, 1995.

Transport Layer Security Working group, “The SSI Protocol, Version 3.0”, Nov. 18, 1996 Deborah Radcliff, “Universal servers: Does one size fill all?”, Software Magazine, May 1997.

“Internet Cash,” by Internet Cash Corporation, www.internetcash.com (publication date unknown). “CashX,” by CashX, Inc., 2000.

“UniCashe,” by UniCashe.com, Inc., Revision Date Jun. 7, 2001 (original publication date unknown).

Primary Class: 705/74

Other Classes: 705/64, 705/26, 705/39, 705/67, 705/65, 705/41, 705/44, 705/72, 705/77, 705/35, 705/75, 235/380, 235/382, 235/375.

International Classes:

G06Q99/00; H04L9/00; G06Q20/00; G06K5/00; G06F17/60

Field of Search:

705/78, 705/67, 705/65, 235/380, 705/72, 705/77, 705/64, 235/380, 379/144,235/329,

### BACKGROUND OF THE INVENTION

The present invention relates generally method for purchasing goods and services over the Internet (virtual) or Retailers (point of sale—POS-) anonymously. The system is relates to an Anon Virtual Prepaid Internet Shopping Card which is used as a new generation or method of purchase and as a card substitute to conventional credit/debit cards system in order to avoid identity theft and fraud for millions of consumers especially across the Internet, because card/accounts holders are anonymously.

The Internet is a global computer network. The users connect their computers to the Internet indirectly via a standard analog telephone connection or a digital services connection to an IPS, whose computer is more directly connected to the Internet or one of its sub-networks. A software product known as a browser, executing on a user's computer, is used to retrieve the information and cause the user's computer to display it. An IPS may provide a browser to its subscribers that are integrated with the communication software. The Internet is a client-server system in which the user's remote computer operating under a controlled browser constitutes a client platform that requests hypertext documents and the host computer operating under control of its own software constitute a server platform that provides the documents in response to the client's request.

The term “e-commerce” is commonly used to refer to such transactions. Merchants may provide information and offers regarding their products or services in the form of hypertext documents, known as web-sites that they publish on the word wide web (www). Hundreds of millions of dollars per year are spent in the U.S. on purchasing items and services over the Internet. Due to the very nature of the Internet, a company may be based hundreds or even thousands of miles away from the purchaser. The vast majority of commercial transactions occur by providing credit/debit/gift card information, including credit card number and expiration date of the credit card, on a hypertext form or field and transmitting the information to the merchant's server. Once approved, the product may be shipped to the user by conventional means, or it may be delivered electronically via the Internet itself in the case of software or other services provided over the www. A similar process is used for those merchants that accept debit cards.

Each day, most customers present problems, when they make a purchase goods or services from internet merely defrauding consumers. Such companies obtain the personal and credit card information and use it for authorized purchases. Perhaps of equal concern is the providing of credit card information and other personal information to reputable companies who then sell the personal information to marketing firms, telemarketers and others. This can result in a tremendous amount of “junk mail” or “phishing scam” and unsolicited telephone calls to the purchaser who provided such information during a single transaction with one company, but who is contacted subsequently by many other companies in which the purchaser may have no interest.

Identity theft is a major problem not only in America, but through out the world. Many people are still afraid to use their credit cards online, although online credit card transactions are getting safer all of the time. Security remains the main concern about online payment systems.

The biggest issue affecting online payment systems—from both the sellers' and the buyers' perspectives—is maintaining the security of financial and personal information sent over the Internet. A survey conducted by Visa, showed that 91 percent of consumers were concerned about privacy and security on the Internet.

Approximately 95% of websites, online shops, internet merchants, will only accept credit/debit card payments. It has never been easier for to get a credit card. Unfortunately many people even today are deprived of such facility thus keeping the unlimited internet opportunities of success and freedom away from them. Internet payment systems refer to the various methods by which individuals and companies doing business online collect money from their customers in exchange for the goods and services they provide. A number of different forms of payment exist for online purchases, and more are being developed all the time.

After all, it is in the best interest of both consumers and merchants to make electronic commerce as safe and easy as possible. Customers who physically visit retailers or web sites establishments can choose among a variety of payment methods, including cash, checks, credit cards, debit cards, gift cards, smart cards, ACH, digital cash, and old-fashioned payment methods. Customers who shop on the Internet are beginning to expect online merchants to offer the same variety and convenience in payment terms.

Credit cards remain the most common form of payment for online or retailers purchases, although the options have expanded to include digital cash, smart cards, electronic checks, and other technologies. In addition, some customers continue to make online purchases using traditional payment methods, such as placing orders by telephone or fax, or sending a check via postal service.

The merchandising public has become increasingly interested in prepaid cards and gift card with today evolving marketplace. A prepaid card, also commonly referred to as a stored-value card, is typically a debit card-sized piece of plastic that contains or represents an amount of pre-loaded value. The monetary value on a prepaid card typically comes from money given to the card's issuer (or a designee) prior to its use. Prepaid cards frequently have a magnetic stripe and a card number that is associated with an account on a separate database, which number is used to track the monetary value associated with the account. Similarly, gift card generally have a certificate number printed on the certificate, which number is associated with a database, which number is used to verify that the certificate is authentic. Purchasers often elect to buy prepaid cards (including but not limited to gift cards which can be used at a merchant, internet or shopping mall). The numerous purchasers of prepaid and gift have acknowledged the practicability inherent in prepaid debit/gift cards which allow the recipients of such gifts to select their own items for purchase (close-loop).

However, it is not uncommon that a prepaid a gift cards will go unused. The recipients of these cards may have no interest in frequenting the merchants or utilizing the services of the merchants at which the cards or certificates may be used, or may find it inconvenient to do so because are close-loop.

Accordingly, there is a need for a system which allows doing purchases over the Internet with the same convenience and ease as with the use of credit or debit cards, protecting the identity theft and credit card fraud.

The present invention is a card designed for the millions of customers around the world who are victims of identity theft and credit card fraud without revealing the identity of the holder using an anonymous method descript as: a PIN number, 3 CVC and an expiration date, without name stored on the card/account to prevent abuse personal and financial information across the Internet. The present invention fulfills these needs and provides other related advantages.

An anonymous debit card/account, easy to use, simple, disposable, non-rechargeable, that includes major credit cards logos, for open-loop are crying out for consumers worldwide.

### BRIEF SUMMARY OF THE INVENTION

The present invention has been developed as a new generation of shopping card/accounts or method, (anonymous, disposable and non-reloadable, simple, universal, and secure) with designed amount on the each card/account, and with the same physical characteristics and electronic mechanisms of a financial debit/charge card system so that consumer can complete by Internet (virtual) or in person (plastic) purchase transactions anonymously.

The invention is specifically directed to protecting the financial and identity theft of a card/account holder, whereby the card/account holder can to do over an e-commerce or retailers transactions in complete anonymity, the detailed description of the invention that now follows is represented in terms of processes and symbolic representations of operations carried out by a credit, debit or gift cards processing system. Drawings and features of these systems and methods are described in further detail.

Is in a method for making purchase transactions over the www or shopping mall/retailers (person to person/POS) without any personally identifying information, such as telephone number, social security number, date of birth, annual income, etc.,

A card is purchased (virtual or plastic) having a unique identification codes a) PIN number (16-digit account number), b) a expiration date of 4 digits (00/00) and c) 3 digit security codes or CVC), and a predetermined cash balance under every card/account.

A virtual account is provided via e-mail through the Internet, to the customer, the account with the PIN, the 3CVC and ED is: a) using the same tool, mechanisms and financial debit card system and working as major credit/debit card; b) is an anonymous prepaid disposable and non-reloadable account to be used for on-line purchasing; c) each account have a value witch is determined by the consumer at time of purchase by buying goods or services, can only be made as long as the prepaid value of the account (does not exceed the amount/value of the cash balance ). The consumer simply enters the account information as the usual form of payment is a major credit/debit card into the web-page of the merchant.

A Card (plastic) is provided via retailers as shopping mall, gas station, etc, to the customer, the card with the PIN, the 3CVC and ED is: a) method of purchasing by retailers—Point-of-Sale-(POS) using the same tool, mechanisms and financial debit card system; b) providing consumers a financial anonymous prepaid disposable and non-reloadable card to be used for retailers purchasing; c) choosing the value of the card is determined by the consumer at time of purchase; d) working the same as a financial credit/debit cards, as Visa, MasterCard, Discover or American Express; e) buying goods or services, can only be made as long as the prepaid value of the card (does not exceed the amount/value of the card). The consumer simply enters the card information as the usual form of payment is a major credit/debit card by internet or POS machine.

An obstruction on the card, such as a peel-away strip, covering the identification code is removed after purchasing the card.

An account/card is activated or created by providing the information codes to a card customer service system.

The activating step may comprise calling the card customer service system by telephone and providing the identification code (sent by e-mail or rear on the card), such as by inputting the identification codes via keystrokes of a keypad of the telephone when prompted by an automated system, or providing the identification code by voice/receptionist when the automated system has voice recognition software. Alternatively, the account or card holder may enter the identification code into a designated field of a card service web-site to activate account.

An approval code is transmitted to the seller if the identification is valid and a sufficient cash balance is available in the associated account to purchase the selected goods or services. The seller is credited the value of the purchase price of the selected goods or services, and the purchase price of the selected goods or services are debited from the cash balance of the account. If it is determined that the identification code is invalid, or there is insufficient cash balance in the associated account to purchase the selected goods or services, a denial code is transmitted to the seller.

For account/cardholder current balance must be contacting via web site.

In this sense, an account/card is an International payment tool to all who carry it. Card/account is anonymous, no-refundable and disposable with a cash balance limit that cannot be exceeded due to the nature, is used as an account virtual or plastic card as the major credit/cards, giving main access to shopping on-line, telephone, retailers or mail orders; Card/account is too, used at Yahoo, Amazon, EBay, Click Bank PayPal, Google, Skype, iBill, etc, is accepted and can be used to buy anything, can even be used to pay for downloading MP3 music or information. Card/account for any automated teller machines (ATMs) can not be usage for cash back. Other advantages to the present invention can be viewed and interpreted through the drawings presented in this document.

### BRIEF DESCRIPTION OF THE SEVERAL VIEWS OF THE DRAWING

The accompanying drawings illustrate the invention. In such drawings:

FIG. 1 is a flow charts that illustrating the steps taken in acquiring a card or account in accordance with the present invention;

FIG. 2 is a flow chart that shows the steps taken in toll-free to customer service to obtain activating a card or account in accordance with the present invention;

FIG. 3 is a flow chart that shows the steps taken in database and prompt/reception entry activating a card or account in accordance with the present invention;

FIG. 4 is a flow chart that shows the steps taken for validation approved or denied an activating a card or account in accordance with the present invention;

FIG. 5 is a flow chart that shows the steps taken, after activating a card or accounts, a balance in accordance with the present invention;

FIG. 6 is a flow chart that shows illustrating the steps taken in making a purchase over the World Wide Web or Retailers using an Anon Virtual Prepaid Internet Shopping Card in accordance with the present invention;

FIG. 7 is a flow chart that shows illustrating the steps taken in verifying fulfilling a purchase from a merchant to holder in accordance with the present invention;

FIG. 8 is a flow chart shows illustrating the steps taken in a payment of purchase of goods and services to the customer purchaser in accordance with the present invention;

FIG. 9 is a flow chart showing, the steps taken in verifying of goods and services to the holder's in accordance with the present invention;

FIG. 10 is a flow chart that shows illustrating the steps taken through a website, records, history and balance for the card/account and financial institution proposes, verifying and fulfilling all payment and charges from a merchant to a holder in accordance with the present invention;

### DETAILED DESCRIPTION OF THE INVENTION

For the purpose of the present invention reference will now be made to the embodiment illustrated in the drawings and specific language will be used to describe the same is concerned with a method for making purchases over the Internet or Retailers using an Anon Prepaid Internet Shopping Card. as shown in the drawings for purposes of illustration.

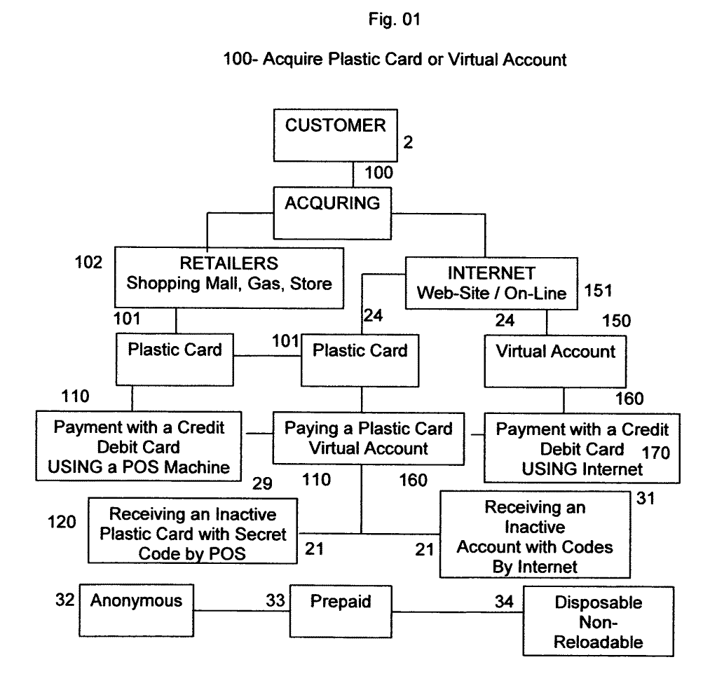

With reference to FIG. 1, a plastic card (101) or a virtual account (150) that is acquires (100) through the Retailers (102) as a shopping mall, stores, gas station or by Internet (151). Plastic Card and Virtual Account having secrets identification codes (21) as: a) PIN number, b) an expiration date of 4 digits and c) 3 digit security codes. The card (101) and account (151) are similar to a prepaid debit card or telephone card because have pin number, an expiration date and a security code. Virtual account (150) and (24) and plastic card (101) are issued in currently available in 7 load amounts (18): US$ 30, 50, 70, 100, 200, 500 and 1,000 with full purchasing power in the American Dollar currency. The virtual account only works through the Internet. Plastic cards works in both channels retail and the Internet, and usually like any retail stores. (Scanning or swiping a magnetic stripe through a POS machine).

Virtual account (150) has not any design, simply information concert to de account as: a) PIN number; b) an expiration date of 4 digits and c) 3 digit security codes and is sent via e-mail to the customer end (24). Plastic card (101) is pre-printed in various designs, trademarks, logos, etc. An account is established in conjunction with a web site with a starting account balance related to the predetermined monetary value. As a user shops at the web site, their account balance is reduced as items are purchased or cost is changed.

A virtual account is provided via e-mail (24) through the Internet with the end user of the account. Plastic card comes pre-printed with various amounts, designs, trademarks, logos, etc (101). Card/account having cash balance (40) available can to works with a commercial transaction are establishing in relation to a website or a retailer to make the purchase of goods or services between the holder and the trader and according to the cash balance of the card/account.

The card/account not uses encryption, is an open loop or network, each card is an account, each account is a account are based on existing Internet protocols therefore can be used in any trade where it generally received as a means of payment major credit card. There is always an electronic payment system using a multifunctional prepaid card that is commonly used for use in payment of services and procurement of goods, and a method of selling prepaid card multifunctional. The electronic payment system includes a personal identification number (PIN) a expiration date and security codes (21) to make purchases of goods and services (45) and to facilitate the buying and selling to dealers who provide users with a prepaid card as well, according to the electronic payment system, a single prepaid card can be widely used in the payment for the purchase of various products or services between a buyer and a seller (600). This invention meets the action of an electronic shopping legitimately used in the world, because it is backed by a financial institution recognized (15) (50).

The card is sold by Retailers or Internet and is accepted by a web site (31) or POS (29) when presented by the end user. It is managed by an issuing institution, (14) which verifies the presence of sufficient funds to cover the cost charged (51) and deducts (52) the charge cost (70) from the card value. Card/account is valid for up to 1 year and any remaining balances, even after expiration, not can be transferred to a new card.

The virtual account (101) or plastic (150) card is a single load and cannot be reloaded with additional funds (60); account and card are anonymous (32), prepaid (33), disposable and no-reloadable (34).

The Card/account will neither be paid, nor earn interest on, the funds loaded on their. The Cardholder (2) has no right to cancel a Card/account for any reason. No refunds will be given. One or more filters are used to restrict the types of products can be purchased at the Web site. On the back of the card (39R) is printed much of the information on the instructions for use and management, a Web site and customer service by toll-free are available to the holder.

The part concerning the security codes (21) (PIN number, expiration date and security codes) for plastic card are hidden under the protection zone (20) of aluminum with a special ink scratch-off treatment, (19) to prevent abuse until the purchase of the card has not been paid the distributor or the card issuing institution. Plastic cards (101) remain inactive (120) in the shelf of a retailer willing to be sold and paid to retailer (110). The purchaser must first activate the card to make a purchase of goods and services

The part concerning the security code (21) for accounts are sent to the buyer via e-mail address. A virtual account (150) is inactive (170) shipped, when is paid (160) to the distributor (4) to the buyer (2) via e-mail waiting to be activated by the latter via customer service (200).

Buyer is responsible for al kind of abuses until the purchase of the card has not been paid to the distributor or the card issuing institution (14) (15).

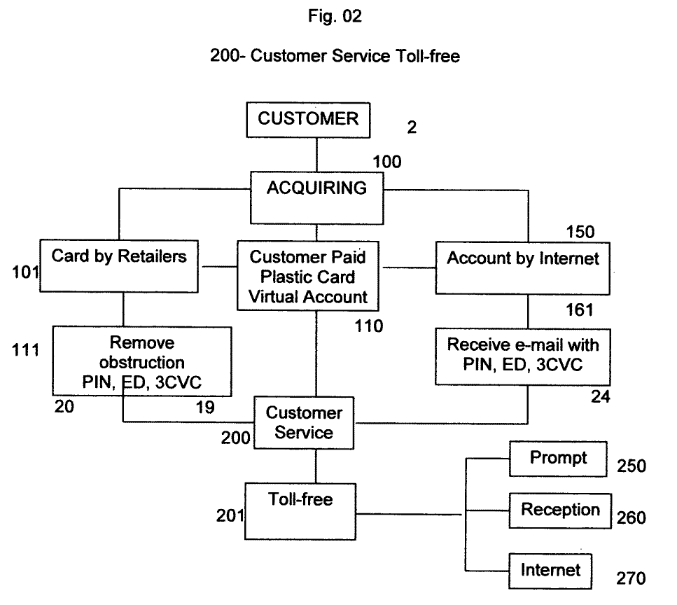

With reference to FIG. 2 the diagram illustrates possible architecture how a customer (2) can to have access to Customer Services (200). After acquiring (100) and purchasing the card (110) the owner/customer (2) should proceed to remove the obstruction (111) and covering the PIN number, expiration date and security codes that are hidden under the protection zone (20) of aluminum strip with a special ink scratch-off treatment (19) the customer will be to toll-free (201) to customer service system (200) in order to obtain an activation approved (300). After acquiring (100) and purchasing an account (150) the owner/customer (2) should proceed to received the PIN number, expiration date and security codes (21) that are sent via e-mail (151) (24) whom will be to toll-free (201) to customer service system (200) in order to obtain an activation approved (300). The card/account holder service system may be contacted by telephone or eventually by internet. The system is automated and has three options to address the so-called activation: a) reception speaking (260) into the phone when asked by the automated system to have voice recognition software; b) Prompt (250) Automatically by using the keyboard or of a keypad of the telephone when pulsations he asked, c) alternatively, the owner of the card can connect to the Internet, (270) and enter the identification codes in a designated area of card/account issuance systems via web-site services (21).

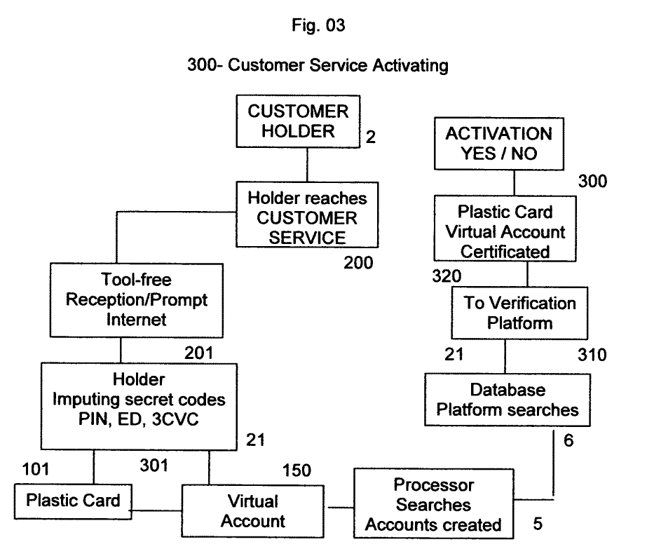

With reference to FIG. 3, the diagram illustrates possible architecture and provides as provides information capture system for activation (300). The card/account customer service system (200) is accessed by end users (2) throw toll-free (201), either cardholders or sellers, using either the telephone interface prompt (250), reception (260) or the Internet network interface (270), and imputing (301) a secret codes of the card and or account (21) as described above. Upon contacting the card customer service system (200) and inputting the secret codes (21), an activation processor (5) searches a card/account database (6) to match the provided identification code (21) with a previously generated account, or an account is created and certified for verification proposes. If the certification processes (310) are valid a plastic card and a virtual account are activated (300), otherwise will be denied.

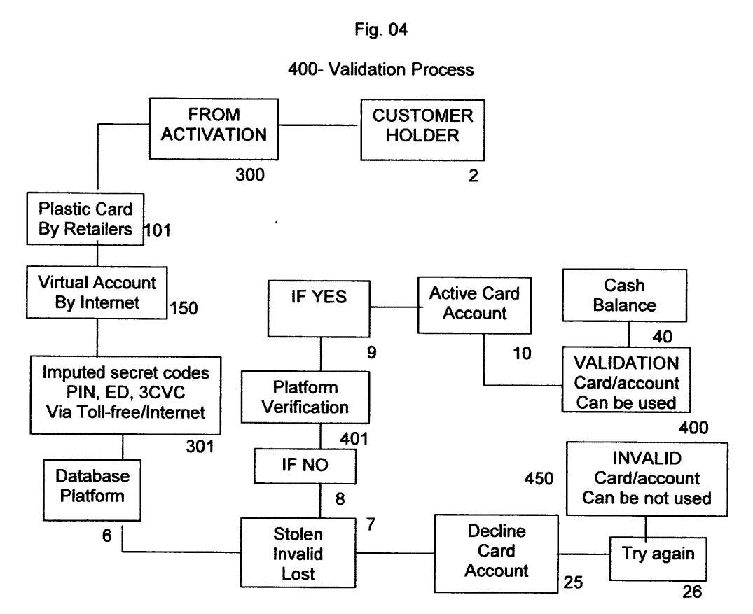

With reference to FIG. 4 the diagram illustrates how a customer user (2) purchaser of the plastic card (101) or virtual account (150) is prompted to obtain validation (400). Several identification codes number is imputed (301) before certification (320). If the identification codes numbers (21) of the card or account are determined by processor search (5) and database (6) to be valid (400), the plastic card or virtual account are activated, (300) and the database (6) and platform (401) provides the current cash balance (40).

If the identification codes numbers (21) are determined by processor search (5) and database (6) to be invalid (450), the end customer user (2) purchaser of the card (101) or account (150) is prompted to try again (26). A preset number of attempts (510) can be provided in any given call, before the system automatically ends (200).

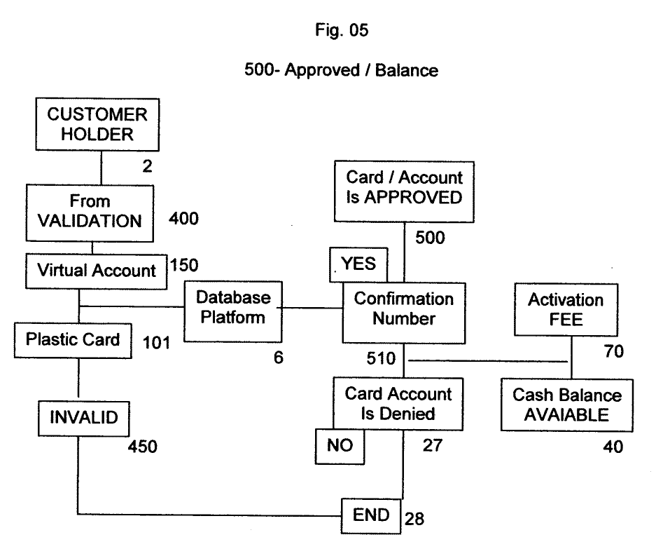

With reference to FIG. 5 the diagram illustrates steps for approbation and balances of the card/account (500). After a Plastic card (101) or virtual account (150) has been activated (300) the process is as follows: The platform (6), and the database (5) gives validation (400). If information is valid (9), an activation (10) process beginning and a confirmation number (510) can be provided in any given call, before the system automatically ends (200) and say “your card account is ready to be used” as approved signal. Once activated account or a card will automatically be deducted from the first activation fee (70) which has been predetermined under terms and conditions. A cash balance (40) available appears on the card/account as the amount for purchase of goods and services. Customers/User (2) going to the retailers and internet to make purchase of goods and services.

After a Plastic card (101) or virtual account (150) is denied (27) or not has been approved the process is as follows: The platform (6), and the database (5) issues a certificate warning that the card can not be used (450). When a notification of invalidation (8) is obtained, a confirmations number (511) can be provided in any given call, before the system automatically process ends (200).

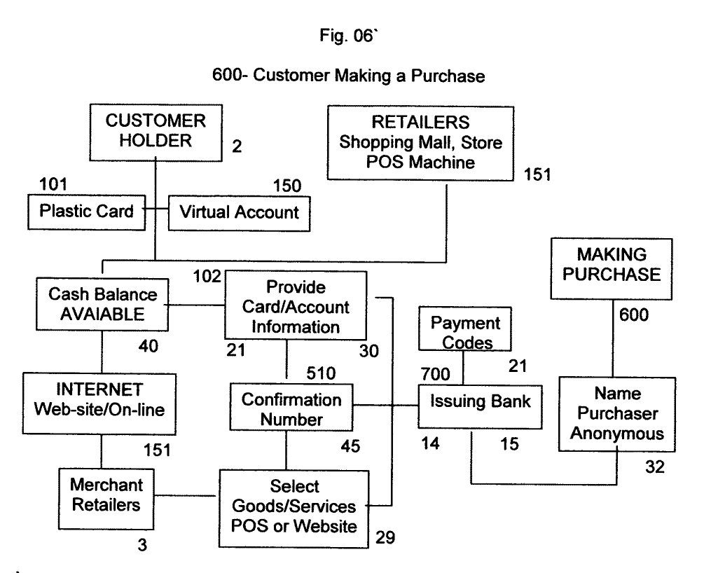

With reference now to FIG. 6, graphics show how to make purchase transactions over the Internet (151) and retailers (102), the holder connects with a desired web-site or retailer. The holder (2) of the a virtual account or a plastic card then selects various goods or services (45) and requests purchase of these through the web-site (151) or Internet using a POS machine (29). Instead of providing account/information (30), the user inserts the prepaid account identification codes (120) into a designated field on the web-site (151) or POS (29). The seller then contacts the card issuing company (14) (15), such as by network connection, and transmits the provided identification codes (21) to verify the identification codes and obtain payment (800) for goods and/or services (45). The card service system and platform (401) determines if there is a sufficient cash balance (40) in the account to purchase the selected goods or services. If the identification codes is determined to be valid and a sufficient cash balance is available in the associated account to purchase the goods or services, an approval (500) code is sent (510) to the seller granting approval of the purchase (510). An anonymous holder name (32) is necessary filed, such as delivery (900) address (910) is provided to the cart of the seller, and the purchase is ends (28). A denial code is transmitted to the seller if the identification code (511) is determined to be invalid (450) or there is insufficient cash balance in the associated account to purchase the selected goods or services (45) the purchase no-approved and is ends (28).

With continued reference to FIG. 1, and with reference to FIG. 6 when a cardholder purchases goods and services at a retailer (101), the retailer or the purchaser may swipe the card through the purchase venue system, such as a POS (29) terminal, which reads the account number from the magnetic stripe on the card (16). Alternatively, the retailer or purchaser may manually enter the card or account number from the keyboard of the POS (29) terminal or telephone the information into a location to obtain a verbal authorization. The retailer or purchaser may then input into the purchase venue system the purchaser's requested monetary load value to be loaded to the card (18). The card and monetary load value information are then transmitted over data base (6) to the account verification system (700). The system POS (29) interrogates the Processor Searches (5) to find a record associated with a card number that matches the transmitted account number.

If no card number is located in the database (6) that matches the transmitted card number (21), the system (29) (401) transmits a message to the purchase venue system via data base and Platform (6) informing the retailer that activation of the card has been denied (57) or approved (51). If a plastic card in database (6) matches the transmitted card number (21), the system (401) interrogates the record associated with the card number to determine if the card number has been reported as, invalid, lost or stolen (7). If the account number has been reported as lost or stolen, (7) the system (6) transmits a message to the purchase venue system via data informing the retailer that activation of the card has been denied (27). If the card number has not been reported lost or stolen, the parameters may be transmitted to the system (6) with the card number and monetary cash balance. The system (6) may then transmit a message (510) to the purchase system (29) (31) indicating that the card number is valid (700) and the end user can to do a purchase.

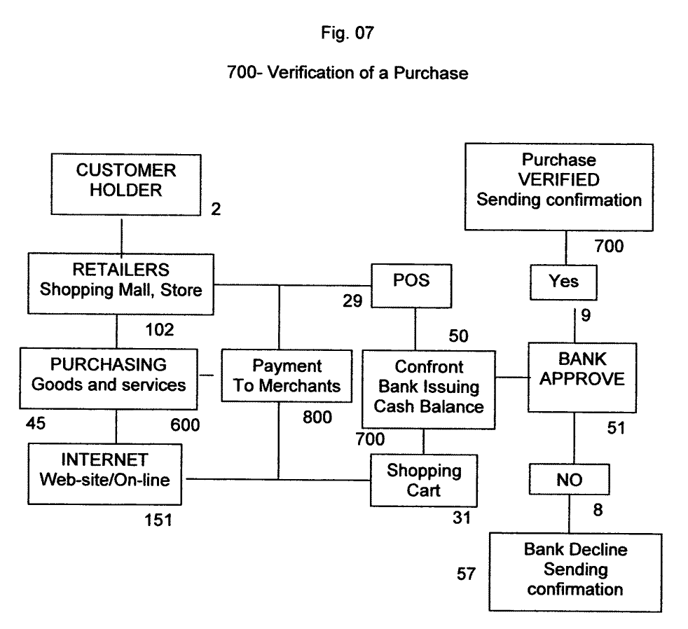

With reference to FIG. 7, graphics show how after making a purchase with retailers (102) and Internet (151), receive a verification from the issuing bank (700) to pay back (800). The customer or holder (2) of a plastic card (101) that has made a purchase of goods or services (45) through the internet or in retail, the procedure for verification of purchase (700), is as follows. When the purchase is made through a retailer (102) with a plastic card (101), the customer (2) or vendor access to the POS machine (29), in order to swipe the card through the purchase venue system, such as a POS terminal, which reads the plastic card number (30) from the magnetic stripe (16) on the card (101) who in turn send the information on the card codes (21) and if this is valid, the bank issuing the card (14) & (15), through its database and compares this information gives validation retailer for selling their products or services. The issuing bank (50) sends an instant signal to the retailer as proof of approval (51) of the commercial transaction

When the purchase is made through Internet (151) with a virtual account (150), the customer or vendor access his/she database, system, platform or shopping cart, in order to provide all virtual account information to the system, such as a merchant shopping cart (31), which supplies, delivers, type codes (21) of the account number (150) who in turn send the information on the virtual account codes and if this is valid (8), the bank issuing the card through its database and compares this information gives validation (510) retailer for selling their products or services. The issuing bank (50) sends an instant signal to the merchant as proof of approval (51) of the commercial transaction

If the plastic card (101) and virtual account (150) information is invalid (8), the bank issuing of the card or account through its database gives an invalidation (57) notice to retailer for selling their products or services. The issuing bank (50) sends an instant signal to the retailer as proof of decline of the commercial transaction and it will automatically ends all transaction.

After the transaction is verified (700) end, if the card holder has a remaining balance (40), the holder can conduct additional commercial transactions. In the event that the holder has not kept track of the balance of the card account, or reaching a zero balance, the corresponding card account will be closed because the virtual account and plastic card is disposable and no-reloadable (34).

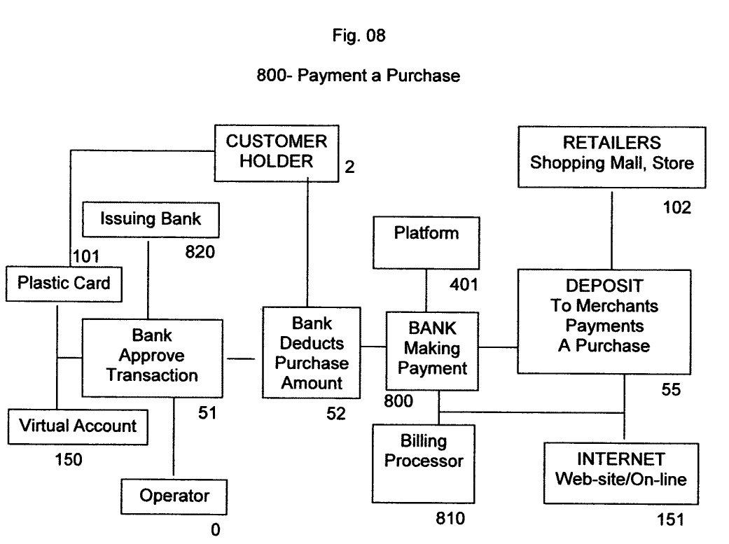

With reference to FIG. 8, chart show step about payment a purchase. Merchant receive payment request from the issuing bank (820) to the operator (0) and holder (2) provided confirmation number (510) is received by the card customer service system (200). After Bank approve (51) and deducts (52) automatically cost and fees (70) for purchase of goods and services (45) render to the customers. Billing processor (810) and Platform (401) of the Operator (0) and Merchants (3) offers multi-purse technology, a proprietary bill payment service, integrated ACD and IVR, world-class customer service, and real-time connectivity to retails locations that accept cash loads to prepaid cards. Bill Platform (401) provides consumers with multiple solutions including full, daily spending records, bill payments, cash balance, reward programs, account alerts, and live customer service. Platform is safeguards for the consumer's primary account or card number when making purchases online, phone or retailers. Electronic payments are processed in real time.

After receiving a payment (800), bank processes (810) transaction and made automatically deposits (55) to the merchant account. Banks are responsible of the deposit to the merchants' accounts. If the card holder has a remaining balance, the holder can conduct additional commercial transactions. In the event that the holder has not kept track of the balance of the card account, or reaching a zero balance, the corresponding card account will be closed because the account/card are disposable and no-reloadable (34).

The merchant bills the purchase to the issuing bank, which pays the merchant and bills the main account. The process (810) is the same as that for the corresponding type of conventional or major credit card, thus ensuring wide acceptance for the electronic debit card.

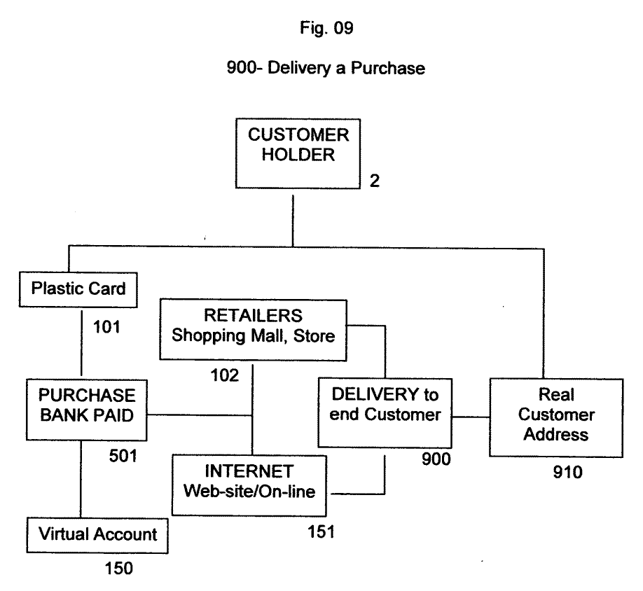

With reference to FIG. 9, graphics show how to make delivery of purchase. When a holder make transactions from the Internet (151) or retailers (102), for a purchase of goods or services (45), merchants utilizing same mail system or distributor (e.g. UPS), items are shipping (900) to the addressed (910) card holder (101) or account holder (150) or purchaser. After purchase is paid (800) retailers and merchants makes a delivery to the end user to a valid US address but the customer name could be anonymous (32). It will be appreciated that the anonymous customer address should preferably contain a proper real shipping address for each received goods or services purchased.

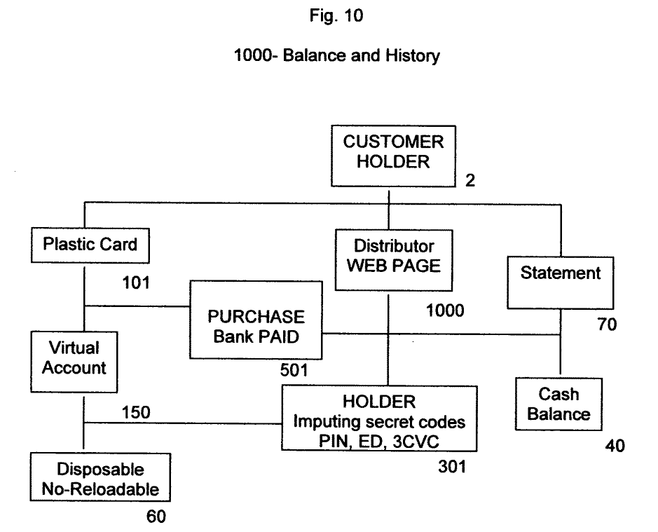

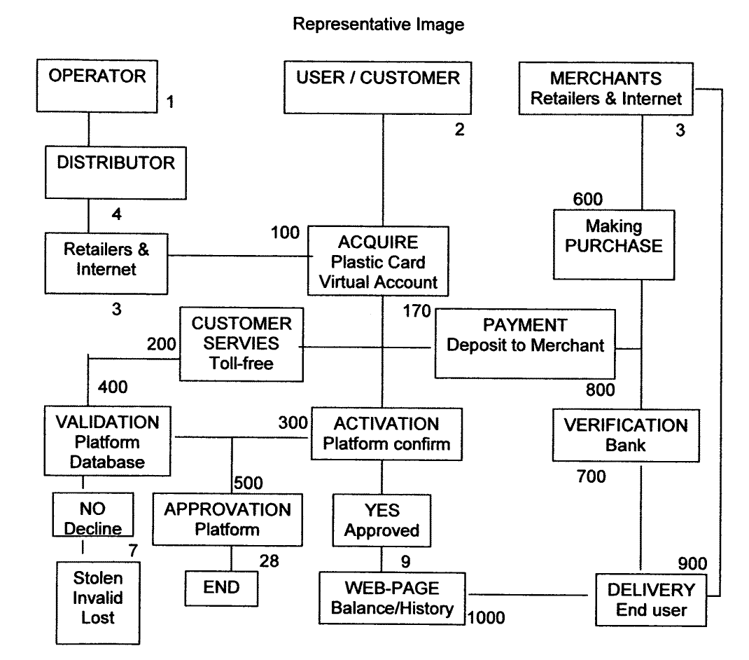

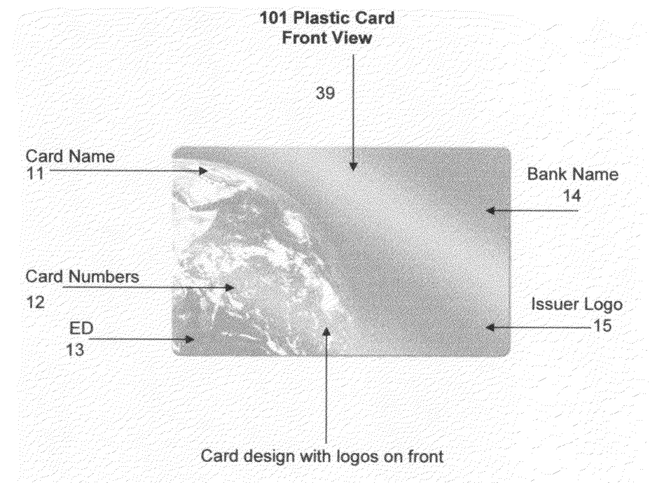

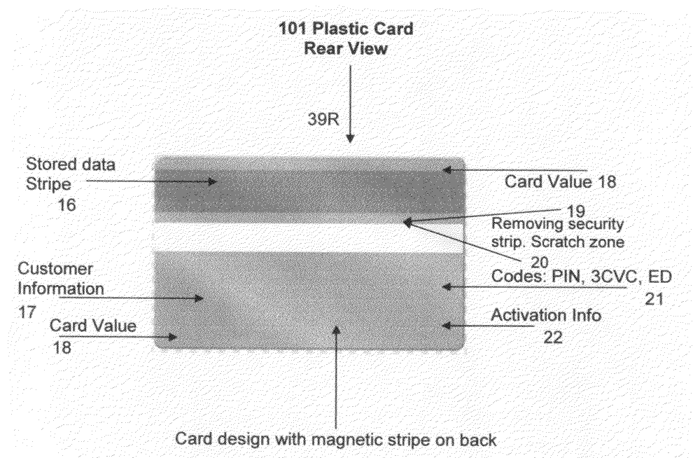

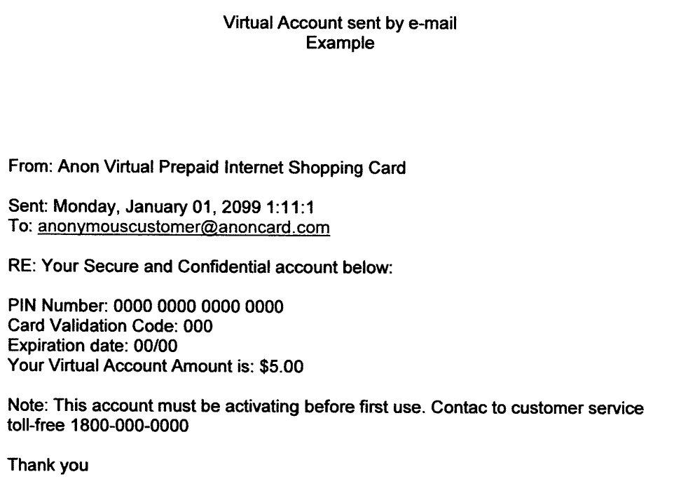

With reference now to FIG. 10, graphics show how a balance or history is view across card/account's webpage. All kind transactions for purchase of goods or services (45) paid (510) and deduct (52) from the plastic card (101) or an account (150) are checked via internet. Customer/User (2) imputing secret codes (21) can to obtain from the Distributor (5) or Operator (0) or through a page-web an activity statement (70) or a Cash balance (40).

With continued reference to FIG. 10, database (6) of the card/account operator (0), Distributor (4) or Merchant (3) system has a plurality of records, each record having a plurality of fields. The database/platform may have only records that are associated with a card/account numbers. Each record associated with a plastic card (101) and virtual account (150) number has stored in a field a card/account number (21) similar to, or derivable from, the number which has been printed, embossed, encoded or the like on a card/account. Each such record also has a field for storing a monetary value (18) associated with the card/account number. Each record (70) also may have a field that indicates whether the card/account number is activated or non-activated and has been reported lost or stolen, a field indicating the expiration date of the card/account number, a monetary value has been charged. Going to the web site and imputing the secret codes, holders can to obtain your statements (70) or cash balance (40). The record may further include any additional fields for storing information, requesting any inquiry relating to the balance, transaction history (1000) of the card/account number.

The present invention is directed to a system and method for providing complete electronic commerce (“E-Commerce”) transactions and solutions for a marketing company's products via the World Wide Web or point-of-sale; In another aspect, the present invention relates to the combination of a marketing business with a buying opportunity using a electronic commerce transactions is know as an Prepaid shopping card

Identity theft involves acquiring key pieces of someone's identifying information, such as name, address, date of birth, social security number, etc., in order to impersonate them. This information enables the identity thief to commit numerous forms of fraud, which may include: a) taking over the victim's financial accounts or obtaining fraudulent financial accounts; b) making purchases in the victim's name; c) applying for loans, credit cards, social security benefits, etc.; d) establishing services with utility and phone companies. The Consequences: a) credits destroyed. B) Spend many hours on the phone and writing letters attempting to resolve the situation. c) Difficulty in writing checks, obtaining loans, renting an apartment or buying a home; and d) receives bills and demands for payment for purchases that you never made.

A lack of consumer confidence and nervousness about sending personal and private banking information across the sometimes unsafe internet have left some consumers out of the shopping loop. While the internet is accessible to a limitless number of individuals, only some feel safe spending money online. The lack of security, privacy, and the non-availability of a universal form of payment is blocking the development of e-commerce. The fraudulent use of credit and debit card over the internet and the viruses used to obtain credit card numbers are discouraging to shopping, leaving them off line.

Although detail description of the invention have been described in detail for purposes of illustration, various modifications of each may be made without departing from the spirit and scope of the invention. Accordingly, the invention is not to be limited, except as by the appended claims.

While the invention has been illustrated and described in detail in the drawings and foregoing description, the same is to be considered as illustrative and not restrictive in character, it being understood that only the preferred embodiment or detailed description of several views of the drawing has been shown and described and that all changes and modifications that come within the spirit of the invention are good faith and desired to be protected.

The present invention is specifically directed to protecting the identity theft of a credit cardholder whereby the cardholder can enter into credit card transactions in complete anonymity. Since the cardholder's identity is protected, the cardholder has the freedom to purchase any goods or services without worrying about receiving unwanted mailings or being personally harassed.

Definitions:

The following definitions apply to words and/or terms used herein and are offered to clarify their use and intended meaning and not as a means of limitation.

Acquire: A customer in person or virtual that purchase a plastic card or virtual account throw the retailers or internet

Card: A instrument such as a charge card, credit card, debit card, awards card, prepaid card, telephone card, smart card, magnetic stripe card, bar code card, transponder, gift card and/or the like having an account number, with a) PIN number (16-digit account number), b) a expiration date of 4 digits (00/00) and c) 3 digit security codes or CVC),who is typically present to a merchant retailers as part of a transaction, such as a purchase. The card may be distributed and stored in any form of plastic, electronic, magnetic, data, value, account, disposable, non-reloadable, anonymous, prepaid. Account number: May be used herein, a) PIN number (16-digit account number), b) a expiration date of 4 digits (00/00) and c) 3 digit security codes or CVC), to allow the consumer to interact or communicate. The account number may be distributed and stored in any form of paper, e-mail, message, electronic, wireless, or virtual account send/received by e-mail, data, value, account, disposable, non-reloadable, anonymous, prepaid.

Customer account/card: May be, a) PIN number (16-digit account number), b) a expiration date of 4 digits (00/00) and c) 3 digit security codes or CVC), no name card holder is recorded on the card, although each credit provider has its own numbering system.

Card and/or Account holder: An entity, typically an individual person that has been issued a card or is authorized to use a card. The customer can receive the card for personal use or send it to a third party, either as a gift or as payment for a purchase.

Anonymous: As stated, it is often desirable to protect the identity of consumers having an anonymous card/account, name, address, as described before, makes a purchase from a merchant or internet. The purchase can be over the telephone, over the Internet, retailer, POS, shopping cart, or any other computer network, or via any other means available as retailers.

Chargeback: A reversal of a transaction which is “charged-back” to the Acquirer from the Issuer.

Dispute Claim: Any request that may initiate a dispute resolution process from a cardholder to an Issuer; from an Issuer to an Acquirer. It includes information about a disputed charge as might occur when the merchant/retailers failed to comply with regulations and/or terms of the card acceptance agreement with the Acquirer.

Fulfillment: The response that an Acquirer sends to an Issuer in response to a Retrieval Request, and includes information and possibly documents in support of a Dispute claim.

Issuer: Typically a bank or other financial institution typically operating under regulations of a card issuing association or entity and which issues cards to cardholders. An issuer of pre-paid electronic debit cards contracts with an issuing bank for a main account compatible with an existing network of credit cards such as MasterCard, Visa, Discovery or American Express.

Major credit card: MasterCard, Visa, Discovery or American Express

Merchant: Also known as a web site, e-commerce, store, shopping mall, is any entity, individual, organization, software and/or hardware that supports a transaction using a card or information derived from a card. Merchant or Retailers may be Point of Sale (POS) devices, web-page, etc. bound to agreements with Acquirers to accept cards from cardholders to charge purchases of goods and services or for cash access.

E-commerce: concerns about paying for online, internet, www, purchases.

Customer Services: Provides comprehensive customer support and various departmental operations including: chargeback's, customer care, fraud, activation, and employee training. Customer services operate with a receptionist, prompt or automatic machine.

Distributor: An organization or set of organizations involved in the process of making a product or service available for use or consumption by a consumer or business user.

Database/Platform: is a collection of related card/account information, accessed and managed by Platform. Manages information about types of real entities for control, verification, validation, activation, approbation and more details for acquires.

Codes: a) PIN number (16-digit account number), b) a expiration date of 4 digits (00/00) and c) 3 digit security codes or CVC)

Disposable: refers to features of a card/account elements that enhance its suitability for no-reuse. Designed to be disposed after zero balance.

Non-Reloadable: cards/accounts that can be used for any purchase only when there cash balance or money is available on these cards. Cards/Account is not reloadable or rechargeable.

Anonymous: Card/account or Customer/User that have not named in order to prevent their identity theft.

Prepaid: Card/Account Paid in advance.

Toll-free: Calls made to a telephone number that has an 800/866/877 area code are billed to the called party rather.

Delivery: Transporting of goods and services purchased for a holder from retailers/internet to the real address from end user.

What is claimed is:

1. A payment system to allow transmission or transactions of a purchase “virtual or in person”, including the current use of payments methods of the financial debit/account/credit/charge card system. Is a new generation of anonymous shopping card (plastic) or account (virtual), with same physical characteristics and electronic mechanisms of a financial debit card system so that the consumer can complete by Internet (virtual) or in person (Point Of Sale) a purchase of goods and services. The card/account is anonymous, prepaid, easy to use, disposable and non-rechargeable with a predetermined value and information stored in his/she data base and includes: a) a personal identification number [PIN], b) four digits of expiration date (ED) and c) 3-digit of validation code—3CVC-; there is no name as recorded on the card holder or account holder because it is anonymous. The card/account does not use encryption because it is an open network; each card/account is an account and is based on existing protocols of the Internet. The card/account with a cash balance after deduction of an activation fee is ready to make purchases of goods or services through the Internet or in retailers. Activation of the account/card must be before first use. Its use is simple and limited only to the fact of giving to the merchants the basic information contained on the card/account (PIN, expiration date and security code) and no other information relevant to the holder's because it is anonymous, they are then transmitted to the system or the card issuing bank for verification, including verification system to determine if the codes assigned to the card/account are valid and are associated with a card or account is valid and if active (authentic) and if there is enough cash in the balance of the account or card to purchase goods or services selected, and the subsequent transfer of an approval code or confirmation to the seller if the information supplied by the purchaser of goods and services is valid, as a sign of approval and payment, if a source refuses, denied, or is not valid if there is insufficient available balance of cash in the account or card to purchase goods or services selected, not transmitting an approval code or confirmation from the seller to the buyer to refuse the commercial transaction. Thus, according to electronic payment system, a single prepaid card/account can be widely used as many times as necessary provided there is availability of cash balances in order to pay the seller and deduct costs. Business transactions are done in real time. The card or account is used in the same transaction and in lines like a major credit card Visa, MasterCard, American Express and Discover. This prepaid card/account protects the identity of a consumer and financial information due to the nature of the invention and can be used online or in retail stores at the same time as it is an open-loop. Cards/accounts are not permitted to be used in automatic teller machines (ATM) to withdraw cash.

2. The method of claim 1, wherein the step includes a method of Internet purchasing with a prepaid anonymous debit account (virtual) comprising: a) using the same tool, mechanisms and financial debit card system, b) providing consumers a financial anonymous prepaid disposable and non-reloadable account to be used for on-line purchasing; c) choosing the value of the account is determined by the consumer at time of purchase; d) working the same as a financial credit/debit cards, as Visa, MasterCard, Discover or American Express; e) buying goods or services, can only be made as long as the prepaid value of the account does not exceed the amount/value of the cash balance. The consumer simply enters the account information (codes) as the usual form of payment is a major credit/debit card.

3. The method of claims 1, wherein the step includes a method of purchasing by retailers—Point-of-Sale—(POS) with a anonymous prepaid debit card (plastic) comprising: a) using the same tool, mechanisms and financial debit card system; b) providing consumers a financial anonymous prepaid disposable and non-reloadable card to be used for retailers purchasing; c) choosing the value of the card is determined by the consumer at time of purchase; d) working the same as a financial credit/debit cards, as Visa, MasterCard, Discover or American Express; e) buying goods or services, can only be made as long as the prepaid value of the card (does not exceed the amount/value of the card). The consumer simply enters the card information (codes) as the usual form of payment is a major credit/debit card.

4. The method of claims 1, and 2 wherein including the step of receiving a virtual account provided via e-mail through the Internet, using mobile telephone network, gateway or message to the customer, the account with the secret codes (PIN, the 3CVC and ED) for purposes of the activation after purchasing the account.

5. The method of claims 1 and 3, wherein including the step of removing a security strip zone (as a peel, away strip) printed over plastic card covering the PIN, the 3CVC and ED for purposes of the activation after purchasing the card. Encoded label comprises at least one of the groups of a bar code label or a magnetic strip.

6. The method of claims 1, wherein the step includes the activation card/account through of a toll-free customer service in order to confirm and provide the activation for a card/account through valid information (PIN, the 3CVC and ED). Activation of the virtual account and or a plastic card must be before first use.

7. The method of claims 1, wherein the step of activation card (plastic) includes inputting the PIN, the 3CVC and ED—via keystrokes of a keypad—of the telephone when ask prompted by an automated system or voice receptionist of customer service.

8. The method of claims 1, wherein the activating account (virtual) includes entering the PIN, the 3CVC and ED designated on the account and sent by e-mail service—via keystrokes of a keypad—of the telephone when ask prompted by an automated system or receptionist of customer service.

9. The method of claim 1, wherein including the step of crediting the seller with the value of the purchase price at the selected goods or services debiting the amount from the card/account balance imputing simply a secret codes (PIN, the 3CVC and ED).

10. The method of claim 1, wherein including step of holder/customer anonymous to determine the current balance of the card/account through a web site that is available to customers.

11. The method of claims 1, wherein including the step of transferring all costs (purchase, fees, etc) to the card/account holder in order to obtain a balance through a web site that is available to customers.

12. The method of claim 1, which includes determining step of an active search database for a PIN, the 3CVC and ED of the accounts (virtual) and cards (plastic) on the platform verification.

13. A method of claims 1, wherein step is performed over the Internet or by retailers for providing an electronic code (PIN, the 3CVC and ED) for account or card, which is compatible with an existing network or machine of credit cards, through a financial institution which participates as the usual form of payment is a major credit/debit card.

14. The method of claim 1 wherein it provides a user interface for selecting at least one good or service for purchase in an e-commerce site using a card/account. The user interface comprises an electronic representation of a good or service offered for sale on the e-commerce site, or retailers and an icon associated with the electronic representation that, when selected, causes the representation of the good or service to be placed in an electronic shopping cart.

15. The method of claims 1, wherein for making a purchase transaction from retailers (person to person or point of sale), using a anonymous plastic card or virtual account said is a new generation of anonymous shopping card, with the same physical characteristics and electronic mechanisms of a financial debit/charge card system so that consumer can complete by in person purchase transactions; said. method comprising the steps of: a buyer proceeding to a merchant server to make a purchase; said buyer entering an associated debit card information under his/she POS machine; said POS authorization server using a unique session key to a host secure module; said merchant server creating a payment request based on contents of POS and payment method, wherein merchant server sends payment request to an payments server, said payments server determining a payment type and formatting a payment authorization request; said payment authorization request routing to an POS system, wherein POS system takes encrypted debit card information to acquiring financial institution encrypted card data; if said transaction is on-us (approved), then POS system validating the card and passing an associated transaction amount to a card/account system for authorization; if said transaction is off-us (declined), then authorization request routing to a network for routing to an issuing financial institution of buyer; passing back to said POS system an authorization approval or denial, wherein said authorization approval or denial is routed to Internet payment's server and finally back to merchant bank account.

16. The method as in any one of claims 1, 4, and 5, wherein said a PIN based Internet debit system and method is provided. The system and method allow for the transmission of an e-Commerce Internet or retailer transaction with a debit card/account existing PIN number. In addition, the system and method allow for secure and no encrypted transmission of such PIN and transaction data via Internet (virtual) or POS (plastic) are allowed in order to make payments for the issuing financial institution and merchant. In one detailed description of the invention, a pop-up is used to get control of a user's browser to present a PIN pad such that the user may enter PIN information associated with the user's debit cards/account. In this way, the invention provides debit card/account functionality to retailer and web pages.

17. The method of claim 1, a prepaid anonymous card (plastic) and or an anonymous account (virtual) method are for electronic commerce and retailers comprising the following steps: a) purchasing a anonymous prepaid card and or an account bearing a predetermined stored value and authentication codes; b) sending a transaction payment request accompanied by said prepaid card/account's authentication codes to an e-commerce merchant's web server; c) transmitting e-commerce merchant's web server to a holder for verification of anonymous prepaid card/account's authorization and available value; d) transmitting a payment request to the issuer of prepaid card/account for approval or rejection; e) approving or rejecting transaction payment request; to merchant's bank account; f) providing a cash balance and history to the holder, through a web page.

18. The method of claim 1, a payment system for open loop stored benefit, the payment system comprising: a web-accessible platform or stores available to a merchants and customers for sale or purchase of goods and services from the a holder's card/account for use by a merchant, wherein: the web-accessible platform or stores communicates with any issuing bank and a merchants who accept payments from the card/account; a web interface (internet or POS)that allows the merchant to interact with the web-accessible platform or stores; a debit processing system communicating with a holder; and a payment system that translates between the merchant interface and issuing bank.

19. The method of claim 1, wherein include steps to purchase the present invention (plastic card and virtual account) through wholesales, distributors, retailers, Internet and or any way where be utilized a shopping carts or POS machine by buyers or end users
